(19) United States
(12) Patent Application Publication
(10) Pub. No.: US 2004/0000028 A1
(43) Pub. Date: Jan. 1, 2004

(54) Door hinge system for opening a hinged door in multiple directions

(76) Inventor: Eun Young Kim, Seoul (KR)

Correspondence Address: DARBY & DARBY P.C., Post Office Box 5257, New York, NY, 10150-5257, US

(21) Appl. No.: 10/214,280

(22) Filed: Aug. 6, 2002

(30) Foreign Application Priority Data
Jun. 28, 2002 (KR) 2002-37017

(51) Int. Cl. E05D 15/50

(52) U.S. Cl. 16/230

(57) ABSTRACT

A door hinge system enables a hinged door to be opened in multiple directions, not only at either lateral side, but also either forward or backward at either lateral side of the door, even though the system has a simple construction. In the door hinge system, when the hinged door is pivoted and opened from one lateral side, a hinge pin and at least one guide pin on the hinged door at the lateral side escapes from a hinge pin groove and a guide pin groove of a bracket assembly at the lateral side while a hinge pin at the other lateral side rotates on its own axis and a guide pin at the other lateral side is pivoted along a guide pin groove of a bracket assembly at the other lateral side. Each of the hinge pin grooves extend along an arc constituting a circumference of an imaginary circle whose center is positioned at one of opposite hinge points and whose radius is equal to a distance between centers of the first and second hinge pins.

### BACKGROUND OF THE INVENTION

1. Field of the Invention

The present invention relates to a door hinge system for opening a hinged door, and more particularly to a door hinge system, which enables a hinged door to be opened in multiple directions, that is, to be opened either forward or backward at either lateral side of the door, and which has a simple construction, thereby enabling the door hinge system to be easily manufactured and the hinged door to be conveniently used.

2. Description of the Prior Art

In general, a conventional hinged door, which is provided at a wall of a building, furniture, or an electronic appliance such as a refrigerator, can be opened in only one direction of forward or backward at only one lateral side of the door. However, the hinged door openable at only one side as described above causes many limitations in the design of a building or the arrangement of furniture or electronic appliances. In other words, when a door-holding body, which means a wall of a building, furniture, an electronic appliance, etc., is designed or arranged, a sufficient space in which the hinged door can be pivoted must be secured, which imposes many restrictions on the design or arrangement of the door-holding body.

Several doors and door hinge systems, which enable a door to be opened at either lateral side, left or right side, of the door, have been developed in order to overcome such a problem in the design or arrangement of the door-holding body as described above. For example, U.S. Pat. No. 5,187,836 issued to Kim, et al., entitled “door hinge arrangement for opening the door at either side”, discloses a door hinge system which enables a door to be opened at either lateral side of the door.

However, Kim, et al.'s door hinge arrangement has a relatively complicated construction and a large number of elements including a holder, a receiving plate, various pins such as a stop pin and locking pin, a torsional spring, various grooves, etc., similar to other known doors or hinge arrangements for opening the door at either side.

Moreover, the conventional doors or door hinge systems known up until now, including Kim, et al.'s door hinge arrangement, can enable a door to opened in only one direction of the door from either side, but there has been disclosed no technology capable of enabling a door to be opened either forward or backward at either lateral side of the door.

### SUMMARY OF THE INVENTION

Accordingly, the present invention has been made to solve the above-mentioned problems occurring in the prior art, and an object of the present invention is to provide a door hinge system for opening a hinged door in multiple direction, which has a simple construction and reduced elements, thereby enabling the door hinge system to be easily manufactured at reduced cost.

It is another object of the present invention to provide a door hinge system for opening a hinged door, which enables a hinged door to be opened in multiple directions, that is, to be opened either forward or backward at either lateral side of the door, thereby enabling the hinged door to be conveniently used.

It is another object of the present invention to provide a door hinge system for opening a hinged door in multiple direction, in which it is warned from either side when the hinged door is being used, thereby preventing any persons, especially those at the opposite side of the user, from being damaged or hurt by the hinged door.

In order to accomplish this object, there is provided a door hinge system for opening a hinged door in multiple directions, the door hinge system comprising: at least first and second hinge pin assemblies opposed to each other, the first hinge pin assembly including a first hinge pin and at least one first guide pin, the second hinge pin assembly including a second hinge pin and at least one second guide pin; and at least first and second bracket assemblies opposed to each other, the first bracket assembly having a first hinge pin groove and a first guide pin groove, the second bracket assembly having a second hinge pin groove and a second guide pin groove, each of the first and second guide pin grooves having a circular shape, the first hinge pin groove having a first hinge point which is a center of the first guide pin groove, the second hinge pin groove having a second hinge point which is a center of the second guide pin groove, the first hinge pin groove extending along an arc constituting a first large circumference of a first imaginary circle, the first imaginary circle having a center positioned at the first hinge point and a radius equal to a distance between centers of the first and second hinge pins, the second hinge pin groove extending along an arc constituting a second large circumference of a second imaginary circle, the second imaginary circle having a center positioned at the second hinge point and a radius equal to the distance between the centers of the first and second hinge pins, the first hinge pin and the first guide pin being disposed on an arc constituting the first large circumference and the second hinge pin and the second guide pin being disposed on an arc constituting the second large circumference, so that a first distance between the first guide pin and the second guide pin is smaller than a second distance between the first hinge pin and the second hinge pin, wherein, when the hinged door is pivoted about the first hinge point, the first hinge pin rotates on its own axis on the first hinge point and the first guide pin is guided along the first guide hole about the first pivot pin while the second hinge pin and guide pin are moved into or out of the second hinge pin hole along the second circumference, and when the hinged door is pivoted about the second hinge point, the second hinge pin rotates on its own axis on the second hinge point and the second guide pin is guided along the second guide hole about the second pivot pin while the first hinge pin and guide pin are moved into or out of the first hinge pin hole along the first circumference.

In this case, the first hinge pin and guide pin may be integrally connected through a first connecting bridge, and the second hinge pin and guide pin are integrally connected through a second connecting bridge.

It is preferred that the first bracket assembly has a first bracket body in which at least one first partition member is disposed, the first guide channel being disposed inside of the first partition member, the second guide channel being disposed between the first partition member and the first bracket body, and the second bracket assembly has a second bracket body in which at least one second partition member is disposed, the second guide channel being disposed inside of the second partition member, the second guide channel being disposed between the second partition member and the second bracket body.

The first bracket assembly may comprise first upper and lower partition members, each of which extends in a shape of a hook from a central portion of the first bracket body, and the second bracket assembly comprises second upper and lower partition members, each of which extends in a shape of a hook from a central portion of the second bracket body. In this case, a first inner mouth is formed between a middle portion of the first bracket body and a first outer partition edge of the first upper and lower partition members, and a first outer mouth is formed through a middle portion of a front surface of the first bracket body, each of the first inner and outer mouths having a width nearly equal to a diameter of the first hinge and guide pins, the second inner and outer mouths having a width nearly equal to a diameter of the second hinge pins and guide pins.

Otherwise, each of the first and second bracket assemblies may comprise outer and inner partition members, which are formed inside of each of the first and second bracket bodies and opposed to each other, each of the outer and inner partition members having a shape similar to a segment in a plan view, the outer partition member having a segment shape whose chord is convexly curved while the inner partition member has a segment shape whose chord is concavely curved, each of the first and second hinge pin grooves being formed between the outer and inner partition members, each of the first and second guide pin grooves being formed in a circular shape around the outer and inner partition members and between each of the first and second bracket bodies and the outer and inner partitions.

In this case, two inner mouths are formed each between edges of the inner and outer partition members, and two outer mouths are formed at opposite ends of each of the first and second hinge pin grooves, each of the inner and outer mouths having a width nearly equal to a diameter of the first and second hinge pins and guide pins.

According to another aspect of the invention, the door hinge system may further comprise a first contact switch disposed on the first hinge pin, a second contact switch disposed on the second hinge pin, first lamps electrically connected with the first contact switch and disposed at front and rear surfaces of the hinged door, and second lamps electrically connected with the second contact switch and disposed at front and rear surfaces of the hinged door, wherein the first lamps are turned off when the first hinge pin is placed on the first hinge point and turned on when the first hinge pin escapes from the first hinge point, and the second lamps are turned off when the second hinge pin is placed on the second hinge point and turned on when the second hinge pin escapes from the second hinge point.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of a hinged door and door-holding body, at which a door hinge system for opening a hinged door in multiple directions according to an embodiment of the present invention is provided;

FIG. 2 is an exploded perspective view of a hinge pin assembly and bracket assembly employed in the door hinge system shown in FIG. 1;

FIG. 3 is a plan view of the door hinge system shown in FIG. 1 when the hinged door has been assembled with the door-holding body;

FIGS. 4A to 4G are side views showing modified constructions of various hinge pin assemblies employed in the door hinge system shown in FIG. 1;

FIG. 5 is an exploded perspective view of a hinged door and door-holding body, in which the door hinge system shown in FIG. 1 is arranged in a different manner;

FIG. 6 is an exploded perspective view of a hinged door and door-holding body, at which a door hinge system for opening a hinged door in multiple directions according to another embodiment of the present invention is provided;

FIG. 7 is an exploded perspective view of a hinge pin assembly and bracket assembly employed in the door hinge system shown in FIG. 6;

FIG. 8 is a plan view of the door hinge system shown in FIG. 6 when the hinged door has been assembled with the door-holding body;

FIGS. 9A and 9B are perspective views showing modified constructions of various hinge pin assemblies employed in the door hinge system shown in FIG. 6; and

FIG. 10 is an exploded perspective view of a hinged door and door-holding body, in which the door hinge system shown in FIG. 6 is arranged in a different manner.

### DETAILED DESCRIPTION OF THE PREFERRED EMBODIMENTS

Hereinafter, door hinge systems for opening a hinged door according to several preferred embodiments of the present invention will be described with reference to the accompanying drawings. In the following description and drawings, the same reference numerals are used to designate the same or similar components, and so repetition of the description on the same or similar components will be avoided.

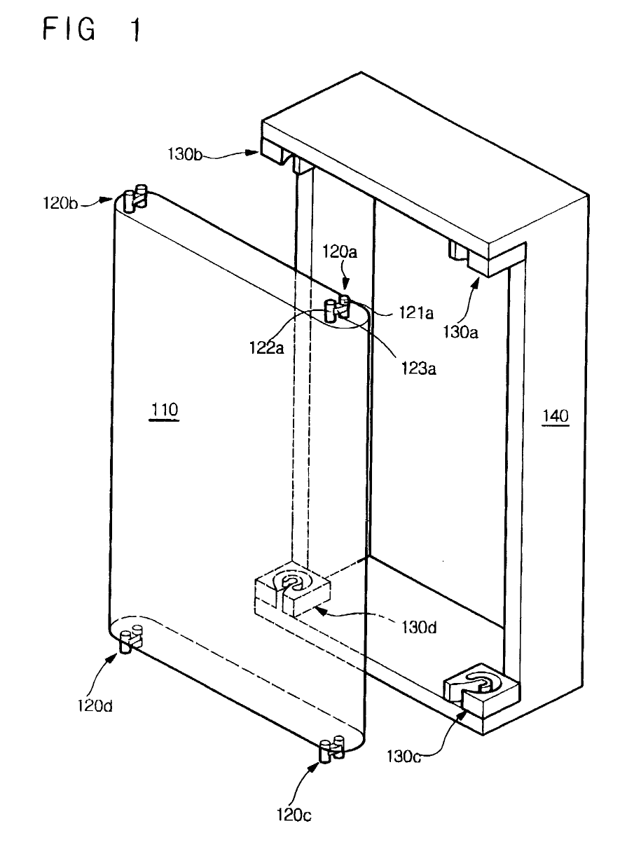

FIG. 1 is an exploded perspective view of a hinged door and door-holding body, at which a door hinge system for opening a hinged door in multiple directions according to an embodiment of the present invention is provided.

Referring to FIG. 1, a hinged door 110 has a rectangular shape, and a door-holding body 140 has a shape of a frame which the hinged door 110 is placed in and supported by. In this case, a door hinge system for opening a hinged door in multiple directions according to an embodiment of the present invention includes first to fourth hinge pin assemblies 120a to 120d, which are provided at corners of upper and lower surfaces of the hinged door 110, and first to fourth bracket assemblies 130a to 130d, which are provided at four corners of the door-holding body 140. The first to fourth hinge pin assemblies 120a to 120d are assembled with the first to fourth bracket assemblies 130a to 130d.

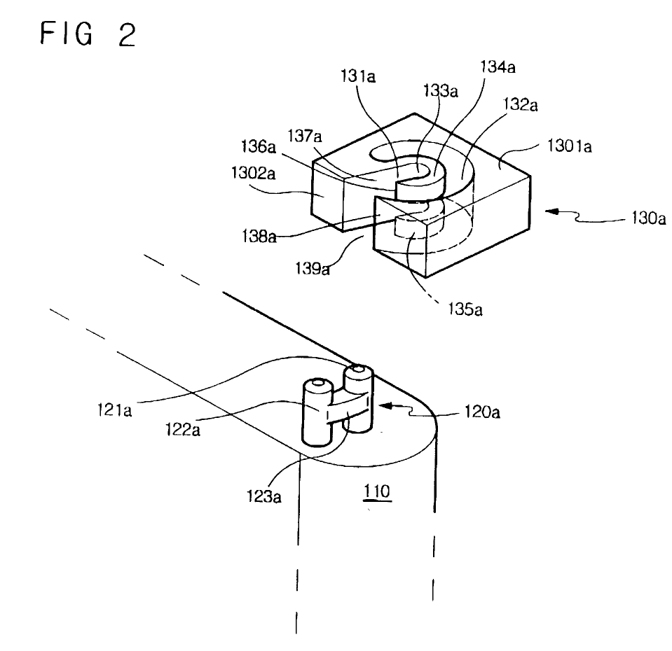

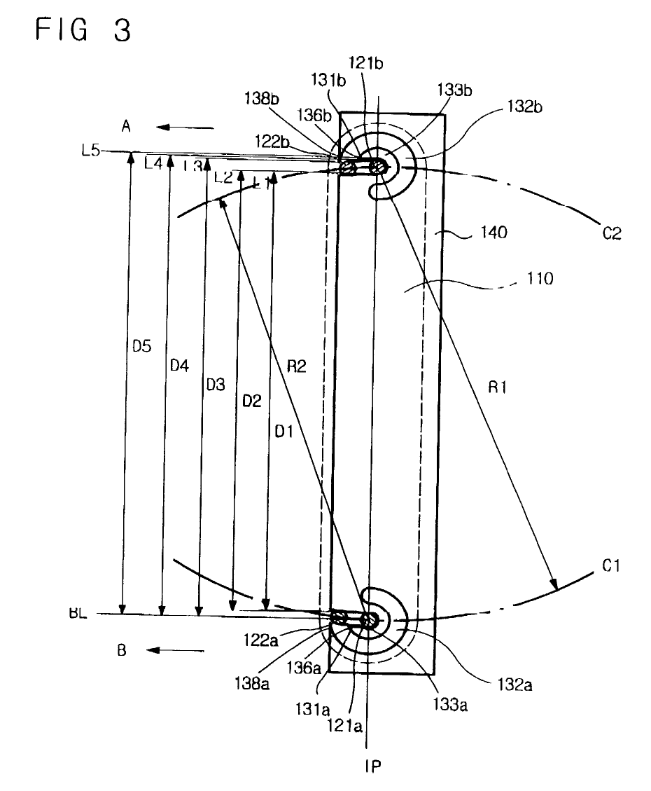

FIG. 2 is an exploded perspective view of a hinge pin assembly and bracket assembly employed in the door hinge system shown in FIG. 1, and FIG. 3 is a plan view of the door hinge system shown in FIG. 1 when the hinged door has been assembled with the door-holding body.

Referring to FIG. 2, the first hinge pin assembly 120a includes a first hinge pin 121a, a first guide pin 122a, and a first connecting bridge 123a connecting the first hinge pin 121a and the first guide pin 122a with each other. The first hinge pin 121a and the first guide pin 122a are formed integrally with the hinged door 110 at a corner portion of an upper surface of the hinged door 110. Of course, the first hinge pin 121a and the first guide pin 122a may be separately formed and fixed to the corner portion through a proper means. The first connecting bridge 123a is formed integrally with and extends horizontally between middle portions of the first hinge pin 121a and the first guide pin 122a.

Further, the first bracket assembly 130a has a first bracket body 1301a in which a first hinge pin groove 131a and a first guide pin groove 132a are formed. First upper and lower partition members 134a and 135a are formed integrally with and extend in a shape of hooks from a central portion of the first bracket body 1301a. The first hinge pin groove 131a is formed inside of the first upper and lower partition members 134a and 135a, and the first guide pin groove 132a is formed between the first bracket body 1301a and the first upper and lower partition members 134a and 135a. In this case, although the first upper and lower partition members 134a and 135a are separately formed in the present embodiment shown in FIG. 2, they may be integrally formed to have an integrated hook-shaped body. A first inner mouth 137a is formed between a middle portion of the first bracket body 1301a and a first outer partition edge 136a of the first upper and lower partition members 134a and 135a, and a first outer mouth 139a is formed through a middle portion of a front surface 1302a of the first bracket body 1301a.

Although FIG. 2 shows only the constructions of the first hinge pin assembly 120a and the first bracket assembly 130a, each of the other three pairs of assemblies, the second to fourth hinge pin assemblies 120b to 120d and the second to fourth bracket assemblies 130b to 130d, also has the same constructions as those of the first hinge pin assembly 120a and the first bracket assembly 130a, so that a detailed description on the second to fourth hinge pin assemblies 120b to 120d and the second to fourth bracket assemblies 130b to 130d is omitted here. Hereinafter, the arrangement between the assemblies will be described in detail.

As shown in FIG. 3, the first hinge pin 121a, the first connecting bridge 123a, and the first guide pin 122a of the first hinge pin assembly 120a are disposed along an arc constituting a first large circumference C1 of a first imaginary circle, the center of which is a second hinge point 133b or the center of a second hinge pin 121b, and the radius R1 of which is the distance between the centers of the first hinge pin 121a and the second hinge pin 121b. Likewise, a second hinge pin 121b, a second connecting bridge 123b, and a second guide pin 122b of the second hinge pin assembly 120b are disposed along an arc constituting a second large circumference C2 of a second imaginary circle, the center of which is a first hinge point 133a or the center of the first hinge pin 121a, and the radius R2 of which is the distance between the centers of the first hinge pin 121a and the second hinge pin 121b, that is, equal to the radius R1. That is, a first distance D1 between the first guide pin 122a and the second guide pin 122b is smaller than a second distance D2 between the first hinge pin 121a and the second hinge pin 121b, and the first hinge pin assembly 120a and the second hinge pin assembly 120b are opposed to each other. Although not shown, it goes without saying that the third hinge pin assembly 120c and the fourth hinge pin assembly 120d, which are located in such manner that they are paired with the first and first and second hinge pin assembly 120a and 120b respectively in the longitudinal direction, are opposed to each other while their elements are arranged in the same manner as those of the first hinge pin assembly 120a and the second hinge pin assembly 120b.

Further, the first hinge pin groove 131a extends from the first outer mouth 139a to the first hinge point 133a along the same trace as the arrangement of the first hinge pin 121a, the first connecting bridge 123a, and the first guide pin 122a. That is, the first hinge pin groove 131a extends along an arc constituting the first large circumference C1. Likewise, a second hinge pin groove 131b extends from a second outer mouth 139b to the second hinge point 133b along an arc constituting the second large circumference C2.

When the first hinge pin groove 131a has a width which is too large in comparison with the diameter of the first hinge pin 121a, there may be too large clearance between the first hinge pin 121a and inner side surface of the first hinge pin groove 131a, which allows the hinged door, for example, to be shaken, generate noise, have shortened lifespan, or have other disadvantages. In contrast, when the first hinge pin groove 131a has a width smaller than the diameter of the first hinge pin 121a, the first hinge pin 121a cannot be inserted in the first hinge pin groove 131a, so that the hinged door cannot be closed. Therefore, it is preferred that the first hinge pin groove 131a has a width equal to or slightly larger than the diameter of the first hinge pin 121a, so that the first hinge pin 121a can be tightly inserted in the first hinge pin groove 131a. More preferably, as well, the first hinge pin groove 131a has a uniform width. The same description can be given to the second hinge pin groove 131b also. That is, it is preferred that the second hinge pin groove 131b has a uniform width equal to or slightly larger than the diameter of the second hinge pin 121b, so that the second hinge pin 121b can be tightly inserted in the second hinge pin groove 131b.

Further, a lubrication ring may be fitted around each of the first and second hinge pins 121a and 121b, so as to reduce friction between the first and second hinge pins 121a and 121b and the first and second hinge pin grooves 131a and 131b, thereby enabling the hinged door 110 can be smoothly opened or closed. The lubrication ring may be made from metal or resin having an excellent abrasion resistance, or may include a roller or bearing. In this case, it goes without saying that the width of the first and second hinge pin grooves 131a and 131b coincides with the outer diameter of an assembled body including the hinge pin and the lubrication fitted around the hinge pin.

By describing the position of a second partition edge 136b of second upper and lower partition members 134b and 135b in detail with reference to FIG. 3, the location and function of the first and second partition edges 136a and 136b will become apparent. A fourth distance D4 from a base line BL, which passes through the first hinge point 133a perpendicularly to an imaginary plane IP passing through the first hinge point 133a and the second hinge point 133b, to a fourth line L4, which passes the second partition edge 136b perpendicularly to the imaginary plane IP, is smaller than a fifth distance D5 from the base line BL to a fifth line L5, a tangent line to the second hinge pin 121b, which is parallel to and farthest from the base line BL and perpendicular to the imaginary plane IP when the second hinge pin 121b is located on the second hinge point 133b. As a result, the second partition edge 136b allows the second hinge pin 121b to move into and out of the second hinge pin groove 131b along the second large circumference C2 but prevents the second hinge pin 121b from moving in the direction perpendicular to the imaginary plane IP. Also, the position of the first partition edge 136a of the first upper and lower partition members 134a and 135a is determined in the same way as above, so that the first partition edge 136a can allow the first hinge pin 121a to move into and out of the first hinge pin groove 131a along the first large circumference C1 but prevent the first hinge pin 121a from moving in the direction perpendicular to the imaginary plane IP.

Further, the first guide pin groove 132a is formed in a circular shape around the first upper and lower partition members 134a and 135a, that is, the first guide pin groove 132a extends nearly entirely along a first small circumference, the center of which is the second hinge point 133b, and the radius of which is the distance between the centers of the first hinge pin 121a and the first guide pin 122a. Likewise, a second guide pin groove 132b is formed in a circular shape around the second upper and lower partition members 134b and 135b, that is, the second guide pin groove 132b extends nearly entirely along a second small circumference, the center of which is the second hinge point 133b, and the radius of which is the distance between the centers of the second hinge pin 121b and the second guide pin 122b. In this case, both of the first guide pin groove 132a and the second guide pin groove 132b have a uniform width equal to or slightly larger than the diameter of the first guide pin 122a and the second guide pin 122b, so that the first guide pin 122a and the second guide pin 122b can be tightly inserted in the first guide pin groove 132a and the second guide pin groove 132b. As a result, the first guide pin 122a can be guided along the first guide pin groove 132a when the hinged door is pivoted about the first hinge pin 121a, while the second guide pin 122b can be guided along the second guide pin groove 132b when the hinged door is pivoted about the second hinge pin 121b.

The first outer mouth 139a has a width equal to or slightly larger than the diameter of the first guide pin 122a, so that a first outer body edge 138a can prevent the first guide pin 122a from being separated from the first guide pin groove 132a, thereby preventing the hinged door 110 from being separated from the door-holding body 140, when the hinged door 110 is pivoted and the first guide pin 122a is located in the first guide pin groove 132a. Also, the second outer mouth 139b has a width equal to or slightly larger than the diameter of the second guide pin 122b, so that a second outer body edge 138b can prevent the second guide pin 122b from being separated from the second guide pin groove 132b, thereby preventing the hinged door 110 from being separated from the door-holding body 140, when the hinged door 110 is pivoted and the second guide pin 122b is located in the second guide pin groove 132b.

Hereinafter, the operation of the above-mentioned door hinge system according to the present embodiment will be described.

First, when the hinged door 110 is pushed or pulled in a direction directed by an arrow A in FIG. 3, the second hinge pin 121b and the second guide pin 122b of the second hinge pin assembly 120b are guided counterclockwise along the second large circumference C2 out of the second hinge pin groove 131b in the direction directed by the arrow A. Simultaneously, the first guide pin 122a is rotated counterclockwise about the first hinge pin 121a in the first guide pin groove 132a while the first hinge pin 121a rotates on its own axis at the first hinge point 133a. As a result, the hinged door 110 is turned counterclockwise and opened at the side of the second hinge pin assembly 120b.

When the hinged door 110 is pushed or pulled in a direction directed by an arrow B in FIG. 3, the first hinge pin 121a and the first guide pin 122a of the first hinge pin assembly 120a are guided clockwise along the first large circumference C1 out of the first hinge pin groove 131a in the direction directed by the arrow B. Simultaneously, the second guide pin 122b is rotated clockwise about the second hinge pin 121b in the second guide pin groove 132b while the second hinge pin 121b rotates on its own axis at the second hinge point 133b. As a result, the hinged door 110 is turned clockwise and opened at the side of the first hinge pin assembly 120a.

Meanwhile, when the hinged door 110 is pulled or pushed in a direction perpendicular to the imaginary plane IP, the first partition edge 136a and the second partition edge 136b prevent the first hinge pin 121a and the second hinge pin 121b from coming out of the first hinge pin groove 131a and the second hinge pin groove 131b respectively, thereby preventing the hinged door 110 from being separated from the door-holding body 140.

After the hinged door 110 is rotated counterclockwise and the first guide pin 122a is located in the first guide pin groove 132a, the first outer body edge 138a prevents the first guide pin 122a from being separated from the first guide pin groove 132a, thereby preventing the hinged door 110 from being separated from the door-holding body 140. Also, after the hinged door 110 is rotated clockwise and the second guide pin 122b is located in the second guide pin groove 132b, the second outer body edge 138b prevents the second guide pin 122b from being separated from the second guide pin groove 132b, thereby preventing the hinged door 110 from being separated from the door-holding body 140.

As described above, the door hinge system according to the present embodiment enables a pivoted door to be opened at either side of the door and can effectively prevent the door from being separated from the door-holding body, although the system has a simple construction.

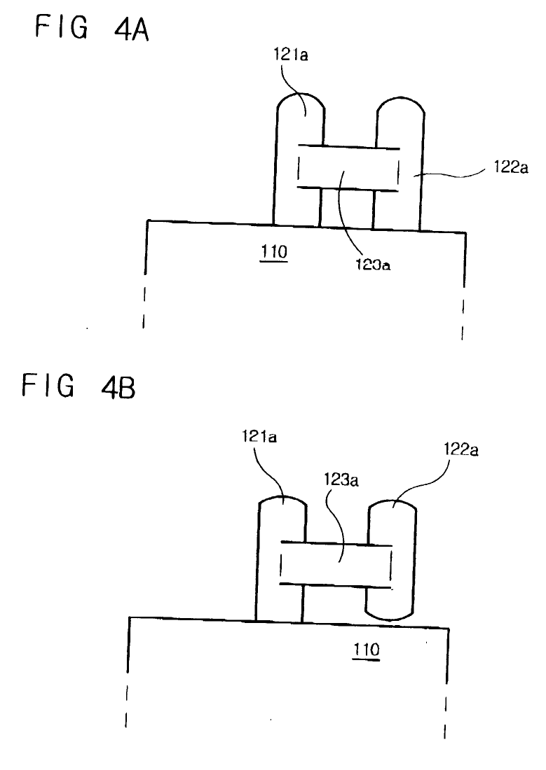

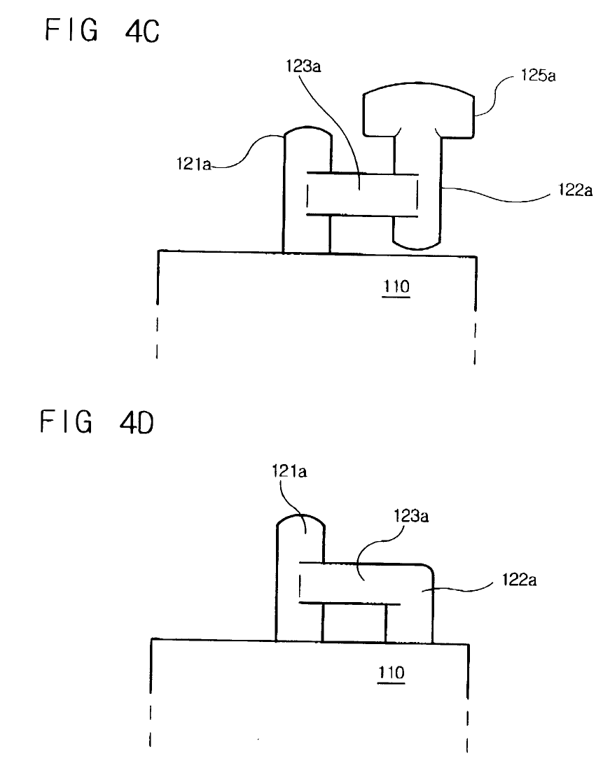

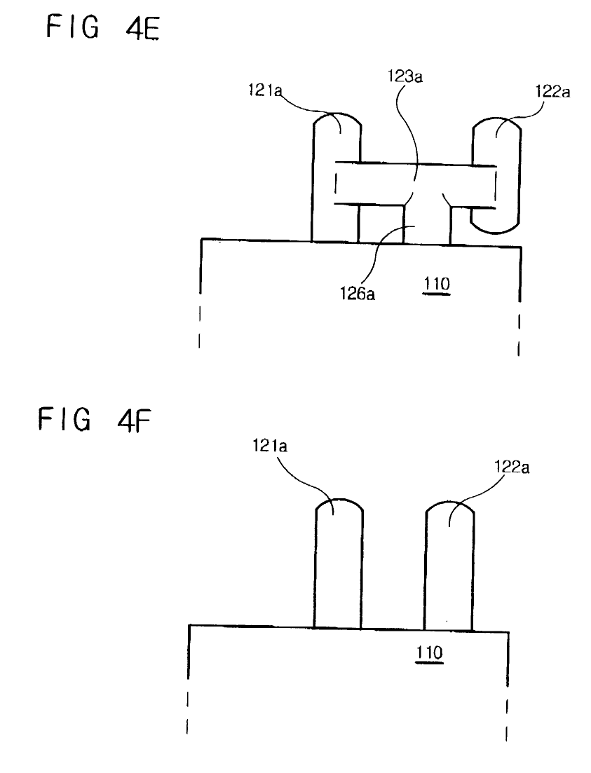

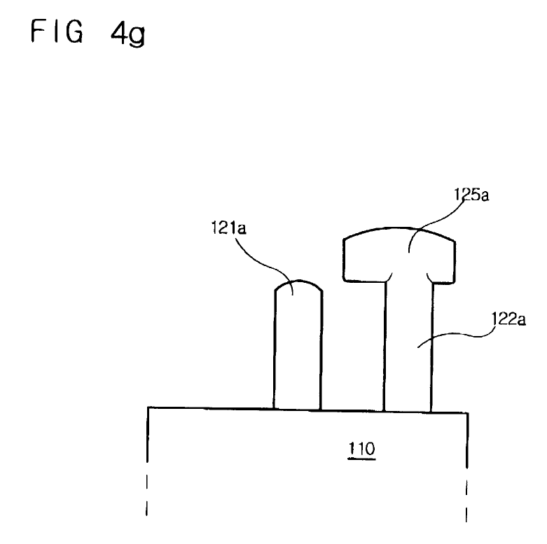

FIGS. 4A to 4G are side views showing modified constructions of various hinge pin assemblies employed in the door hinge system shown in FIG. 1.

FIG. 4A shows a basic construction of the first hinge pin assembly 120a shown in FIG. 1. In the first hinge pin assembly 120a having the construction shown in FIG. 4A, the locations of the first hinge pin 121a and the first guide pin 122a can be stably and firmly maintained.

FIG. 4B shows a first hinge pin assembly 120a having the first guide pin 122a separated from the upper surface of the hinged door 110. In the first hinge pin assembly 120a shown in FIG. 4B, only the first hinge pin 121a is fixed to the hinged door, so that the first hinge pin assembly 120a shown in FIG. 4B is less firmly assembled with the hinged door in comparison with that shown in FIG. 4A. However, the first hinge pin assembly 120a shown in FIG. 4B is suitable for a relatively light door, since it can be assembled through a simple process, thereby highly improving the productivity of the light hinged door. In the first hinge pin assembly 120a shown in FIG. 4B, the first hinge pin 121a and the first guide pin 122a can be inserted and stably located in the first hinge pin groove 131a and the first guide pin groove 132a, respectively, since they are connected with each other through the first connecting bridge 123a.

FIG. 4C shows a guide pin head 125a integrally formed with the upper end of the first guide pin 122a shown in FIG. 4B. When the hinged door 110 has been assembled with the door-holding body 140, the guide pin head 125a is held by the upper surface of the first bracket assembly 130a, thereby helping the door-holding body 140 to suspend the hinged door 110 and preventing the hinged door 110 from shaking or sagging. FIG. 4D shows a first guide pin 122a having only a lower portion without an upper portion. In this case, the first upper partition member 134a may be connected integrally with the first bracket body 1301a, so that the first guide pin groove 132a in which the first guide pin 122a is inserted can be covered by a connecting portion between the first upper partition member 134a and the first bracket body 1301a.

FIG. 4E shows a supporting pin 126a integrally formed with the first connecting bridge 123a so as to support the first connecting bridge 123a. The construction shown in FIG. 4E may be preferably employed in first hinge pin and guide pin assemblies 120a and 130a which are provided at a relatively large and heavy hinged door, and the supporting pin 126a is useful in reinforce the first connecting bridge 123a when the first hinge pin groove 122a and the first guide pin groove 132a are spaced too long distance apart from each other.

FIG. 4F shows a first hinge pin assembly 120a in which the first hinge pin 121a and guide pin 122a are separated and spaced apart from each other without the first connecting bridge 123a. FIG. 4G shows a guide pin head 125a integrally formed on the first guide pin 122a shown in FIG. 4F. According to the present invention, the first hinge pin assembly 120a may have various constructions as well as the constructions shown in figures, for example, it may have at least two first connecting bridges 123a in parallel to each other, instead of one first connecting bridge 123a.

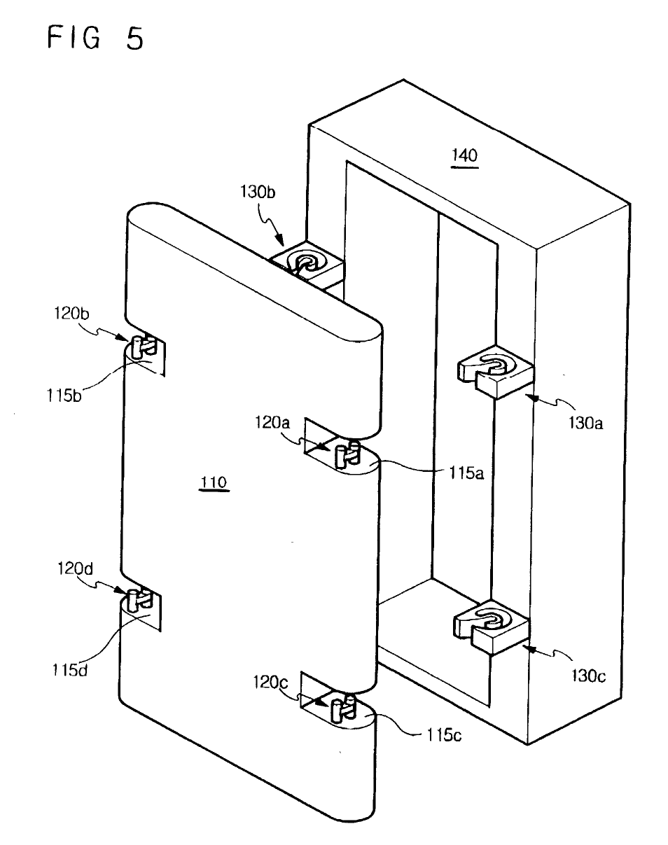

FIG. 5 is an exploded perspective view of a hinged door and door-holding body, in which the door hinge system shown in FIG. 1 is arranged in a different manner.

As shown in FIG. 5, the hinged door 110 has first to fourth pin assembly seats 115a to 115d formed by cutting out middle portions of lateral sides of the hinged door 110, and the first to fourth hinge pin assemblies 120a to 120d are disposed on the first to fourth pin assembly seats 115a to 115d respectively, instead of being disposed on upper and lower surfaces of the hinged door 110. Correspondingly, the first to fourth bracket assemblies 130a to 130d are fixed to middle side portions of the door-holding body 140.

In the door hinge system shown in FIGS. 1 to 5, which is one embodiment of the present invention, the hinge pin assemblies are provided at the hinged door 100, while the bracket assemblies are provided at the door-holding body 140. However, without departing from the scope and spirit of the invention as disclosed in the accompanying claims, locations of the hinge pin assembly and bracket assembly pairing with each other may be exchanged between the hinged door 110 and the door-holding body 140.

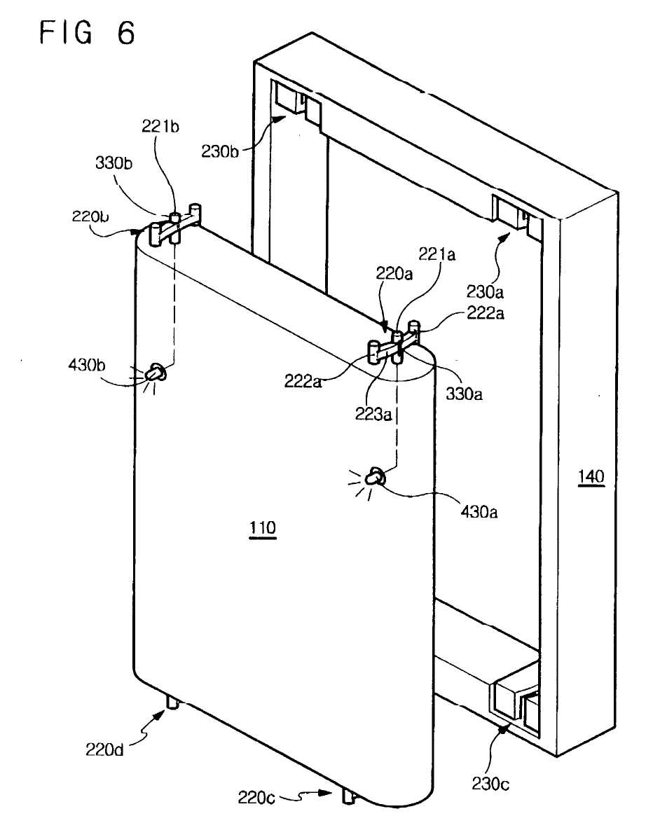

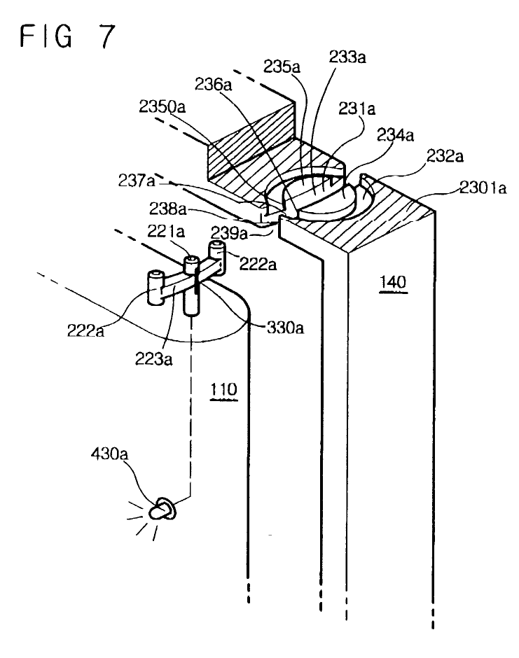

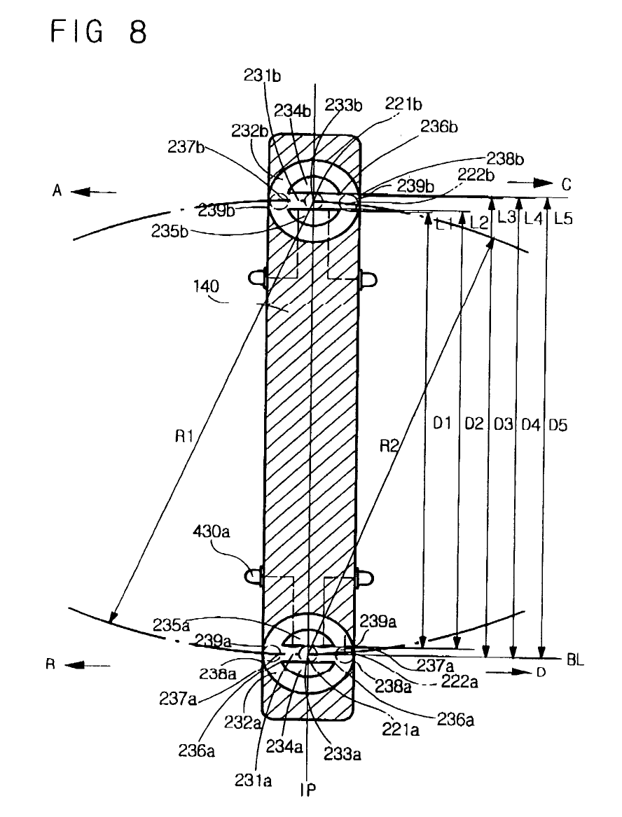

FIG. 6 is an exploded perspective view of a hinged door and door-holding body, at which a door hinge system for opening a hinged door in multiple directions according to another embodiment of the present invention is provided, FIG. 7 is an exploded perspective view of a hinge pin assembly and bracket assembly employed in the door hinge system shown in FIG. 6, and FIG. 8 is a plan view of the door hinge system shown in FIG. 6 when the hinged door has been assembled with the door-holding body.

Referring to FIG. 6, a hinged door 110 has a rectangular shape, and a door-holding body 140 has a shape of a frame which the hinged door 110 is placed in and supported by. The door hinge system for opening a hinged door in multiple directions according to the present embodiment includes first to fourth hinge pin assemblies 220a to 220d, which are provided at corners of upper and lower surfaces of the hinged door 110, and first to fourth bracket assemblies 230a to 230d, which are provided at four corners of the door-holding body 140. The first to fourth hinge pin assemblies 220a to 220d are assembled with the first to fourth bracket assemblies 230a to 230d.

Referring to FIG. 7, the first hinge pin assembly 220a includes a first hinge pin 221a, two first guide pins 222a, and a first connecting bridge 223a connecting the first hinge pin 221a and the first guide pins 222a with each other. The first connecting bridge 123a is formed integrally with and extends horizontally between middle portions of the first hinge pin 221a and the first guide pins 122a.

Further, the first bracket assembly 230a has a first bracket body 2301a in which a first hinge pin groove 231a and a first guide pin groove 232a are formed. Also, the first bracket assembly 230a has first outer and inner partition members 234a and 235a, which are formed inside of the first bracket body 2301a and opposed to each other. Each of the first outer and inner partition members 234a and 235a has a shape similar to a segment in a plan view, but the first outer partition member 234a has a segment shape whose chord is slightly concavely curved while the first inner partition member 235a has a segment shape whose chord is slightly convexly curved.

The first hinge pin groove 231a is formed between the first outer and inner partition members 234a and 235a, and the first guide pin groove 232a is formed in a circular shape around the first outer and inner partition members 234a and 235a and between the first bracket body 2301a and the first outer and inner partition members 234a and 235a. Two first inner mouths 237a are formed each between a first outer partition edge 236a and a first inner partition edge 2350a, and two first outer mouths 239a are formed at opposite ends of the first hinge pin groove 231a. In this case, outer side edges of the first outer mouths 239a will be called “outer body edges 238a” in the following description, and a first hinge point 233a is a position on which a center of the first hinge pin 221a is placed when the door 110 is rotated about the first hinge pin 221a.

Although FIG. 7 shows only the constructions of the first hinge pin assembly and bracket assembly 220a and 230a, each of the other three pairs of assemblies, the second to fourth hinge pin assemblies 220b to 220d and the second to fourth bracket assemblies 230b to 230d, also has the same constructions as those of the first hinge pin assembly and bracket assembly 220a and 230a, so that a detailed description on the second to fourth hinge pin assemblies 220b to 220d and the second to fourth bracket assemblies 230b to 230d is omitted here. Hereinafter, the arrangement between the assemblies will be described in detail.

As shown in FIG. 8, the first hinge pin 221a, the first connecting bridge 223a, and the first guide pins 222a of the first hinge pin assembly 220a are disposed along an arc constituting a first large circumference C1 of a first imaginary circle, the center of which is a second hinge point 233b, and the radius R1 of which is the distance between the centers of the first hinge pin 221a and the second hinge pin 221b. Likewise, a second hinge pin 221b, a second connecting bridge 223b, and second guide pins 122b of the second hinge pin assembly 220b are disposed along an arc constituting a second large circumference C2 of a second imaginary circle, the center of which is a first hinge point 233a, and the radius R2 of which is the distance between the centers of the first hinge pin 221a and the second hinge pin 221b, that is, equal to the radius R1. That is, a first distance D1 between the first guide pin 222a and the second guide pin 222b disposed at the same side is smaller than a second distance D2 between the first hinge pin 221a and the second hinge pin 221b, and the first hinge pin assembly 220a and the second hinge pin assembly 220b are opposed to each other. Although not shown, it goes without saying that the third hinge pin assembly 220c and the fourth hinge pin assembly 220d are opposed to each other while their elements are arranged in the same manner as those of the first hinge pin assembly 220a and the second hinge pin assembly 220b.

Further, the first hinge pin groove 231a extends from the first outer mouth 239a at one side through the first inner mouths 237a to the first outer mouth 239a at the other side along the same trace as the arrangement of the first hinge pin 221a, the first connecting bridge 223a, and the first guide pins 222a. That is, the first hinge pin groove 231a extends along an arc constituting the first large circumference C1. Likewise, a second hinge pin groove 231b extends from a second outer mouth 239b at one side through second inner mouths 237b to the second outer mouth 239b at the other side along an arc constituting the second large circumference C2.

It is preferred that the first hinge pin groove 231a has a width equal to or slightly larger than the diameter of the first hinge pin 221a, so that the first hinge pin 221a can be tightly inserted in the first hinge pin groove 231a. More preferably, the first hinge pin groove 231a has a uniform width. The same description can be given to the second hinge pin groove 231b also. That is, it is preferred that the second hinge pin groove 231b has a uniform width equal to or slightly larger than the diameter of the second hinge pin 221b, so that the second hinge pin 221b can be tightly inserted in the second hinge pin groove 231b.

By describing the position of a second outer partition edge 236b of the second outer partition member 234b in detail with reference to FIG. 8, the location and function of the first and second outer partition edges 236a and 236b will become apparent. A fourth distance D4 from a base line BL, which passes through the first hinge point 233a perpendicularly to an imaginary plane IP passing through the first and second hinge points 233a and 233b, to a fourth line L4, which passes the second outer partition edge 236b perpendicularly to the imaginary plane IP, is smaller than a fifth distance D5 from the base line BL to a fifth line L5, a tangent line to the second hinge pin 221b, which is parallel to and farthest from the base line BL and perpendicular to the imaginary plane IP when the second hinge pin 221b is located on the second hinge point 233b. As a result, the second outer partition edge 236b allows the second hinge pin 221b to move into and out of the second hinge pin groove 231b along the second large circumference C2 but prevents the second hinge pin 221b from moving in the direction perpendicular to the imaginary plane IP. Also, the position of the first outer partition edge 236a of the first outer partition member 234a is determined in the same way as above, so that the first outer partition edge 236a can allow the first hinge pin 221a to move into and out of the first hinge pin groove 231a along the first large circumference C1 but prevent the first hinge pin 221a from moving in the direction perpendicular to the imaginary plane IP.

In addition, the first guide pin groove 232a is formed in a circular shape around the first outer and inner partition members 234a and 235a, that is, the first guide pin groove 232a extends along a first small circumference, the center of which is the second hinge point 233b, and the radius of which is the distance between the centers of the first hinge pin 221a and one of the first guide pins 222a. Likewise, a second guide pin groove 232b is formed in a circular shape around the second outer and inner partition members 234b and 235b, that is, the second guide pin groove 232b extends along a second small circumference, the center of which is the second hinge point 233b, and the radius of which is the distance between the centers of the second hinge pin 221b and one of the second guide pins 222b. In this case, each of the first and second guide pin grooves 232a and 232b has a uniform width equal to or slightly larger than the diameter of the first and second guide pins 222a and 222b, so that the first and second guide pins 222a and 222b can be tightly inserted in the first and second guide pin grooves 232a and 232b, respectively. As a result, the first guide pins 222a can be guided along the first guide pin groove 232a when the hinged door is pivoted about the first hinge pin 221a, while the second guide pins 222b can be guided along the second guide pin groove 232b when the hinged door is pivoted about the second hinge pin 221b.

Each of the first outer mouths 239a has a width equal to or slightly larger than the diameter of the first guide pins 222a, so that the first outer body edges 238a can prevent the first guide pins 222a from being separated from the first guide pin groove 232a, thereby preventing the hinged door 110 from being separated from the door-holding body 140, when the hinged door 110 is pivoted and the first guide pins 222a are located in the first guide pin groove 232a. Also, each of the second outer mouths 239b has a width equal to or slightly larger than the diameter of the second guide pins 222b, so that second outer body edges 238b can prevent the second guide pins 222b from being separated from the second guide pin groove 232b, thereby preventing the hinged door 110 from being separated from the door-holding body 140, when the hinged door 110 is pivoted and the second guide pins 222b are located in the second guide pin groove 232b.

Hereinafter, the operation of the above-mentioned door hinge system according to the present embodiment will be described.

First, when the hinged door 110 is pushed or pulled in a direction directed by an arrow A in FIG. 8, the second hinge pin 221b and the second guide pins 222b of the second hinge pin assembly 220b are guided counterclockwise along the second large circumference C2 out of the second hinge pin groove 231b in the direction directed by the arrow A. Simultaneously, the two first guide pins 222a are rotated counterclockwise about the first hinge pin 221a along the first guide pin groove 232a while the first hinge pin 221a rotates on its own axis on the first hinge point 233a. As a result, the hinged door 110 is turned counterclockwise and is opened in the direction directed by the arrow A at the side of the second hinge pin assembly 220b.

When the hinged door 110 is pushed or pulled in a direction directed by an arrow C in FIG. 8, the second hinge pin 221b and the second guide pins 222b are guided clockwise along the second large circumference C2 out of the second hinge pin groove 231b in the direction directed by the arrow C. Simultaneously, the two first guide pins 222a are rotated clockwise about the first hinge pin 221a along the first guide pin groove 232a while the first hinge pin 221a rotates on its own axis on the first hinge point 233a. As a result, the hinged door 110 is turned clockwise and is opened in the direction directed by the arrow C at the side of the second hinge pin assembly 220b.

When the hinged door 110 is pushed or pulled in a direction designated by an arrow B in FIG. 8, the first hinge pin 221a and the first guide pins 222a of the first hinge pin assembly 220a are guided clockwise along the first large circumference C1 out of the first hinge pin groove 231a in the direction directed by the arrow B. Simultaneously, the second guide pins 222b are rotated clockwise about the second hinge pin 221b along the second guide pin groove 232b while the second hinge pin 221b rotates on its own axis on the second hinge point 233b. As a result, the hinged door 110 is turned clockwise and is opened in the direction directed by the arrow B at the side of the first hinge pin assembly 220a.

When the hinged door 110 is pushed or pulled in a direction designated by an arrow D in FIG. 8, the first hinge pin 221a and the first guide pins 222a are guided counterclockwise along the first large circumference C1 out of the first hinge pin groove 231a in the direction directed by the arrow B. Simultaneously, the second guide pins 222b are rotated counterclockwise about the second hinge pin 221b along the second guide pin groove 232b while the second hinge pin 221b rotates on its own axis on the second hinge point 233b. As a result, the hinged door 110 is turned counterclockwise and is opened in the direction directed by the arrow D at the side of the first hinge pin assembly 220a.

Meanwhile, when the hinged door 110 is pulled or pushed in a direction perpendicular to the imaginary plane IP, the first and second outer partition edges 236a and 236b prevent the first and second hinge pins 221a 221b from coming out of the first and second hinge pin grooves 231a and 231b respectively, thereby preventing the hinged door 110 from being separated from the door-holding body 140.

After the hinged door 110 is rotated clockwise or counterclockwise and the first guide pins 222a are located in the first guide pin groove 232a, the first outer body edges 238a prevent the first guide pins 222a from being separated from the first guide pin groove 232a, thereby preventing the hinged door 110 from being separated from the door-holding body 140. Also, after the hinged door 110 is rotated clockwise or counterclockwise and the second guide pins 222b are located in the second guide pin groove 232b, the second outer body edges 238b prevent the second guide pins 222b from being separated from the second guide pin groove 232b, thereby preventing the hinged door 110 from being separated from the door-holding body 140.

As described above, the door hinge system according to the present embodiment enables a pivoted door to be opened not only at either side of the door but also forward and backward at either side, that is, the door hinge system according to the present embodiment enables a pivoted door to be opened in four directions. Moreover, the door hinge system according to the present embodiment can effectively prevent the door from being separated from the door-holding body. Furthermore, the door hinge system according to the present embodiment has a simple construction even though the system can realize such a new and advantageous hinged door which is openable in multiple directions as described above.

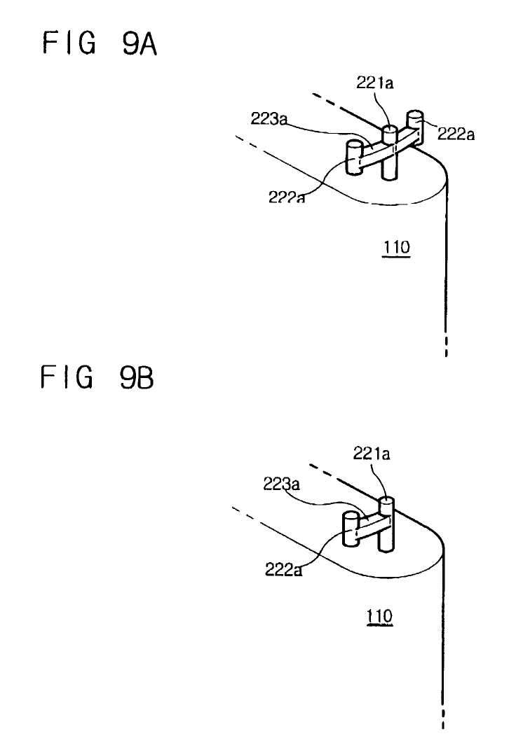

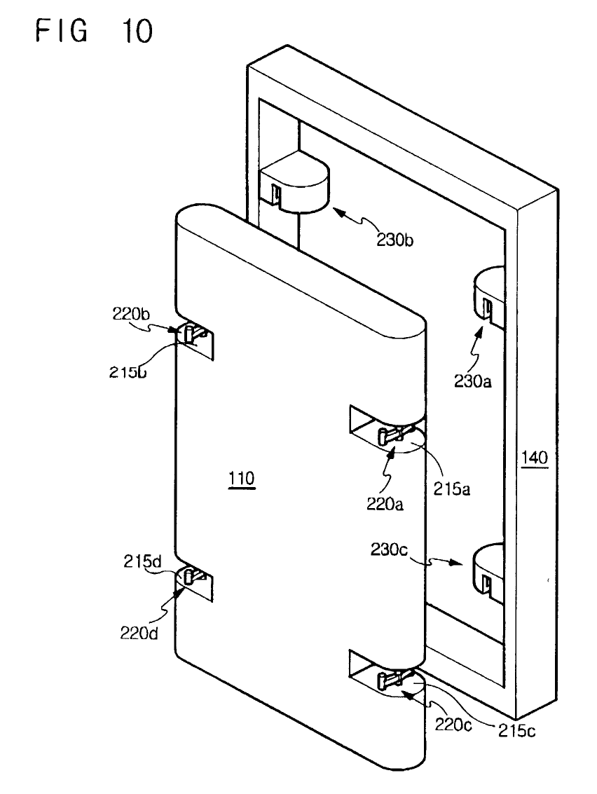

FIGS. 9A and 9B are perspective views showing modified constructions of various hinge pin assemblies employed in the door hinge system shown in FIG. 6.

FIG. 9A shows a basic construction of the first hinge pin assembly 220a shown in FIG. 6, and FIG. 9B shows a first hinge pin assembly 220a having only one guide pin 222a.

FIG. 10 is an exploded perspective view of a hinged door and door-holding body, in which the door hinge system shown in FIG. 6 is arranged in a different manner.

As shown in FIG. 10, the hinged door 110 has first to fourth pin assembly seats 215a to 215d formed by cutting out middle portions of lateral sides of the hinged door 210, and the first to fourth hinge pin assemblies 220a to 220d are disposed on the first to fourth pin assembly seats 215a to 215d respectively, instead of being disposed on upper and lower surfaces of the hinged door 110. Correspondingly, the first to fourth bracket assemblies 230a to 230d are fixed to middle side portions of the door-holding body 140.

Referring again to FIG. 6, the door hinge system according to the present embodiment further includes first and second contact switches 330a and 330b disposed on the first and second hinge pins 221a and 221b, and first and second lamps 430a and 430b disposed at front and rear surfaces of the hinged door 110.

The first contact switch 330a is electrically connected with the first lamps 430a disposed on the front and rear surfaces of the hinged door 110, so that the first lamps 430a are turned off when the first hinge pin 221a is placed on the hinge point 233a and turned on when the first hinge pin 221a escapes from the first hinge point 233a. In order to ensure this operation, it is preferred that two ground electrodes are disposed on the inner surface of the first outer and inner partition members 234a and 235a while being spaced apart from each other.

Therefore, when the hinged door 110 is closed, the first lamps 430a are turned off, since the contact switch 430a is not in contact with the two ground electrodes. In contrast, when a user pushes or pulls the hinged door 110 at the side of the first hinge pin assembly 220a, the first hinge pin 221a escapes from the first hinge point 233a and comes into contact with one of the two ground electrodes. As a result, the first lamps 430a are turned on, so as to warn that the hinged door 110 is being used, thereby preventing any persons, especially those at the opposite side of the user, from being damaged or hurt by the hinged door 110.

The second contact switch 330b and second lamps 430b electrically connected with each other have the same construction, function and operation as those of the first contact switch 330a and lamps 430a, so a description about them is omitted here.

As described above, according to the present invention, the present invention provides a door hinge system for opening a hinged door, which has a simple construction and reduced elements, thereby enabling the door hinge system to be easily manufactured at reduced cost.

Moreover, in the door hinge system for opening a hinged door according to the present invention, a hinged door can be opened in multiple directions, that is, opened either forward or backward at either lateral side of the door, so that the hinged door can be conveniently used.

Furthermore, in the door hinge system for opening a hinged door according to the present invention, when the hinged door is being used, it is warned from either side, thereby preventing any persons, especially those at the opposite side of the user, from being damaged or hurt by the hinged door.

Although several preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A door hinge system for opening a hinged door in multiple directions, the door hinge system comprising:
at least two hinge pin assemblies opposed to each other, each of which is provided at a first one of the hinged door and a door-holding body, the two hinge pin assemblies being, each of the hinge pin assemblies including a hinge pin and at least one guide pin;
at least two bracket assemblies opposed to each other, each of which is provided at a second one of the hinged door and the door-holding body while pairing and being assembled with one of the hinge pin assemblies provided at said one of the hinged door and the door-holding body, the door-holding body holding the hinged door, each of the bracket assemblies having a hinge pin groove and a guide pin groove, wherein,
when the hinged door is pivoted and opened from one lateral side, the hinge pin and the guide pin at said one lateral side escapes from the hinge pin groove and the guide pin groove of the bracket assembly at said one lateral side while the hinge pin at an opposite lateral side rotates on its own axis and the guide pin at the opposite lateral side is pivoted along the guide pin groove of the bracket assembly at the opposite lateral side, and,
when the hinged door is pivoted and opened from the opposite lateral side, the hinge pin and the guide pin at the opposite lateral side escapes from the hinge pin groove and the guide pin groove of the bracket assembly at the opposite lateral side while the hinge pin at said one lateral side rotates on its own axis and the guide pin at said one lateral side is pivoted along the guide pin groove of the bracket assembly at said one lateral side.

2. A door hinge system as claimed in claim 1, wherein at least one of the hinge pin assemblies is provided at the hinged door while at least one of the bracket assemblies, which pairs with said one of the hinge pin assemblies, is provided at the door-holding body.

3. A door hinge system as claimed in claim 1, wherein at least one of the hinge pin assemblies is provided at the door-holding body while at least one of the bracket assemblies, which pairs with said one of the hinge pin assemblies, is provided at the hinged door.

4. A door hinge system as claimed in any of claims 1 to 3, comprising:
at least first and second hinge pin assemblies opposed to each other, the first hinge pin assembly including a first hinge pin and at least one first guide pin, the second hinge pin assembly including a second hinge pin and at least one second guide pin; and
at least first and second bracket assemblies opposed to each other, the first bracket assembly having a first hinge pin groove and a first guide pin groove, the second bracket assembly having a second hinge pin groove and a second guide pin groove, each of the first and second guide pin grooves having a circular shape, the first hinge pin groove having a first hinge point which is a center of the first guide pin groove, the second hinge pin groove having a second hinge point which is a center of the second guide pin groove, the first hinge pin groove extending along an arc constituting a first large circumference of a first imaginary circle, the first imaginary circle having a center positioned at the first hinge point and a radius equal to a distance between centers of the first and second hinge pins, the second hinge pin groove extending along an arc constituting a second large circumference of a second imaginary circle, the second imaginary circle having a center positioned at the second hinge point and a radius equal to the distance between the centers of the first and second hinge pins, the first hinge pin and the first guide pin being disposed on an arc constituting the first large circumference and the second hinge pin and the second guide pin being disposed on an arc constituting the second large circumference, so that a first distance between the first guide pin and the second guide pin is smaller than a second distance between the first hinge pin and the second hinge pin, wherein,
when the hinged door is pivoted about the first hinge point, the first hinge pin rotates on its own axis on the first hinge point and the first guide pin is guided along the first guide hole about the first pivot pin while the second hinge pin and guide pin are moved into or out of the second hinge pin hole along the second circumference, and when the hinged door is pivoted about the second hinge point, the second hinge pin rotates on its own axis on the second hinge point and the second guide pin is guided along the second guide hole about the second pivot pin while the first hinge pin and guide pin are moved into or out of the first hinge pin hole along the first circumference.

5. A door hinge system as claimed in claim 4, wherein the first hinge pin and guide pin are integrally connected through a first connecting bridge, and the second hinge pin and guide pin are integrally connected through a second connecting bridge.

6. A door hinge system as claimed in claim 4, wherein at least one of the first and second hinge pins and the first and second guide pins has a pin head formed integrally with and having a larger width than said one of the first and second hinge pins and the first and second guide pins.

7. A door hinge system as claimed in claim 4, wherein the first bracket assembly has a first bracket body in which at least one first partition member is disposed, the first guide channel being disposed inside of the first partition member, the second guide channel being disposed between the first partition member and the first bracket body, and the second bracket assembly has a second bracket body in which at least one second partition member is disposed, the second guide channel being disposed inside of the second partition member, the second guide channel being disposed between the second partition member and the second bracket body.

8. A door hinge system as claimed in claim 7, wherein the first bracket assembly comprises first upper and lower partition members, each of which extends in a shape of a hook from a central portion of the first bracket body, and the second bracket assembly comprises second upper and lower partition members, each of which extends in a shape of a hook from a central portion of the second bracket body.

9. A door hinge system as claimed in claim 8, wherein a first inner mouth is formed between a middle portion of the first bracket body and a first outer partition edge of the first upper and lower partition members, and a first outer mouth is formed through a middle portion of a front surface of the first bracket body, each of the first inner and outer mouths having a width nearly equal to a diameter of the first hinge and guide pins, the second inner and outer mouths having a width nearly equal to a diameter of the second hinge pins and guide pins.

10. A door hinge system as claimed in claim 7, wherein each of the first and second bracket assemblies comprises outer and inner partition members, which are formed inside of each of the first and second bracket bodies and opposed to each other, each of the outer and inner partition members having a shape similar to a segment in a plan view, the outer partition member having a segment shape whose chord is convexly curved while the inner partition member has a segment shape whose chord is concavely curved, each of the first and second hinge pin grooves being formed between the outer and inner partition members, each of the first and second guide pin grooves being formed in a circular shape around the outer and inner partition members and between each of the first and second bracket bodies and the outer and inner partitions.

11. A door hinge system as claimed in claim 10, wherein two inner mouths are formed each between edges of the inner and outer partition members, and two outer mouths are formed at opposite ends of each of the first and second hinge pin grooves, each of the inner and outer mouths having a width nearly equal to a diameter of the first and second hinge pins and guide pins.

12. A door hinge system as claimed in any of claims 1, 9, and 11, wherein each of the hinge pin assemblies further comprises at least one lubrication ring which is fitted around at least one of the first and second hinge pins, so as to reduce friction between the first and second hinge pins and the first and second hinge pin grooves, each of the first and second hinge pin grooves having a width which corresponds to an outer diameter of an assembled body including said one of the first and second hinge pins and the lubrication ring fitted around the first and second hinge pins.

13. A door hinge system as claimed in any of claims 4, further comprising a first contact switch disposed on the first hinge pin, a second contact switch disposed on the second hinge pin, first lamps electrically connected with the first contact switch and disposed at front and rear surfaces of the hinged door, and second lamps electrically connected with the second contact switch and disposed at front and rear surfaces of the hinged door, wherein the first lamps are turned off when the first hinge pin is placed on the first hinge point and turned on when the first hinge pin escapes from the first hinge point, and the second lamps are turned off when the second hinge pin is placed on the second hinge point and turned on when the second hinge pin escapes from the second hinge point.
